(19) United States
(12) Patent Application Publication
(10) Pub. No.: US 2009/0244125 A1
(43) Pub. Date: Oct. 1, 2009

(54) PRINTING TARGET COLOR SETTING METHOD AND APPARATUS AND PICTURE COLOR TONE CONTROLLING METHOD AND APPARATUS

(75) Inventors: Ikuo Ozaki, Hiroshima-shi (JP); Shuichi Takemoto, Mihara (JP)

Correspondence Address: KANESAKA BERNER AND PARTNERS LLP, 1700 DIAGONAL RD, SUITE 310, ALEXANDRIA, VA, 22314-2848, US

(73) Assignee: MITSUBISHI HEAVY INDUSTRIES, LTD, Tokyo (JP)

(21) Appl. No.: 12/345,404

(22) Filed: Dec. 29, 2008

(30) Foreign Application Priority Data
Mar. 27, 2008 (JP) 2008-084198

(51) Int. Cl. B41J 29/38

(52) U.S. Cl. 347/9

(57) ABSTRACT

The invention provides a printing target color setting method and apparatus and a picture color tone controlling method and apparatus and more particularly provides a printing target color setting method and apparatus and a picture color tone controlling method and apparatus capable of achieving control of the printing color tone more suitably taking dry down of ink into consideration. A color characteristic is acquired in advance which indicates a corresponding relationship between color measurement values obtained by measuring the color of a printed matter for color measurement having a color adjusted to a reference color before and after dry down of ink by means of a reference calorimeter and values of picture data of the printed matter for color measurement. Then, printing picture data to be used for printing are acquired, and then, based on the acquired color characteristic and the acquired printing picture data, target colors before and after dry down corresponding to a value of the printing picture data are set as target values for the color measurement values by an arbitrary calorimeter having a detection characteristic which coincides with that of the reference calorimeter.

### BACKGROUND OF THE INVENTION

1) Field of the Invention

The present invention relates to a printing target color setting method and apparatus and a picture color tone controlling method and apparatus suitable for use with control of a newspaper rotary press.

2) Description of the Related Art

In a printing press for transferring ink to a printing target using a printing plate to carry out printing, since the color (color development) of a printed picture varies depending upon the ink supplying amount, it is necessary to suitably control the ink supplying amount in order to control the printing color to a predetermined color tone.

From such a point of view as just described, the inventors of the present application have developed such a technique for picture color tone control of a printing press as disclosed in Japanese Patent No. 3,825,427 (hereinafter referred to as Patent Document 1).

According to the technique of Patent Document 1, a target density including target values for the density relating to I (infrared light), R (red), G (green) and B (blue) is set for each ink supplying unit width of a printing picture first. Then, an actual density for each ink supplying unit width of an actually printed sheet obtained by printing is measured using an IRGB densitometer. Thereafter, based on a corresponding relationship set in advance, a target tone value of each ink color corresponding to the target density is calculated and an actual tone value of each ink color corresponding to the actual density is determined. Then, a target monochromatic density corresponding to the target tone value of each ink color and an actual monochromatic density corresponding to the actual tone value are calculated based on a corresponding relationship set in advance. Further, a solid density difference corresponding to the difference between the target monochromatic density selected in accordance with the target tone value of each ink color and the actual monochromatic density is calculated based on a corresponding relationship set in advance. Further, the ink supplying amount is adjusted for each ink supplying unit width based on the solid density difference so that the actual density approaches the target density.

Further, the inventors of the present application have proposed, as a technique which can be applied to the setting of a target density for use with the technique disclosed in Patent Document 1, a technique regarding such a target density setting method and apparatus for a printing press as disclosed in Japanese Patent Laid-Open No. 2006-239955 (hereinafter referred to as Patent Document 2).

According to the technique described, a sensor device profile of a reference printing press is produced in advance, and upon printing, the density in each noticed pixel region of a printing picture is calculated from plate making data based on the produced sensor device profile and is set as a target density for a different printing press (controlling target printing press). By applying such a simple procedure as just described, the necessity for preparation of an ICC profile of a reference printing press and an ICC profile of each controlling target printing press can be eliminated and also for preparation of CMS color conversion software on the side of a controlling target printing press can be eliminated.

Incidentally, a phenomenon called dry down that the color development state of a printing picture varies by dehydration of ink occurs in such printing in which ink is used as described above. In particular, in the printing in which ink is used, dehydration of ink progresses with permeation of ink into a printing field and volatilization of solvent components in the ink, and normally the density of color development of a printing picture indicates a decreasing tendency as the dehydration of the ink progresses. This is the aforementioned phenomenon called dry down.

While it is considered necessary to take such dry down of ink as described above into consideration in order to control the color tone of printing, the dry down is not mentioned in Patent Documents 1 and 2.

It is an object of the present invention to provide a printing target color setting method and apparatus and a picture color tone controlling method and apparatus wherein the picture color tone can be controlled appropriately taking dry down of ink into consideration.

### SUMMARY OF THE INVENTION

In order to attain the object described above, according to an aspect of the present invention, there is provided a printing target color setting method comprising a color characteristic acquisition step of acquiring a color characteristic which indicates a corresponding relationship between color measurement values obtained by measuring colors of a printed matter for color measurement adjusted to reference colors before and after dry down of ink with a reference calorimeter and values of picture data of the printed matter for color measurement, a data acquisition step of acquiring printing picture data to be used for printing, and a target color setting step of setting, based on the color characteristic acquired at the color characteristic acquisition step and the printing picture data acquired at the data acquisition step, target colors before and after dry down corresponding to a value of the printing picture data as target values for a color measurement value by an arbitrary calorimeter having a detection characteristic which coincides with that of the reference calorimeter.

Preferably, a single color scale printed matter is prepared as the printed matter for color measurement, and, at the color characteristic acquisition step, colors of the color scale printed matter before and after dry down of ink are individually measured by the reference calorimeter and color measurement values before and after dry down measured by the reference calorimeter and picture data values of the color scale printed matter are associated with each other to acquire the color characteristic.

Preferably, one of a color coordinate value, a spectrum value and a color density value is used as the color measurement value.

Preferably, the picture data is tone value data of each ink color to be used for printing.

Preferably, at the color characteristic acquisition step, the color characteristic is acquired in response to a kind of a material to be used for printing, at the data acquisition step, also material data to be used for printing is acquired, and at the target color setting step, target colors before and after dry down corresponding to the printing picture data and the material data are set based on the color characteristic acquired at the color characteristic acquisition step and corresponding to the kind of the material and also on the printing picture data and the material data acquired at the data acquisition step.

Preferably, the target color setting step includes a noticed pixel region selection step of selecting a noticed pixel region to be noticed as a target of color tone control within a picture of the printing picture data, and the target color is set for the noticed pixel region selected at the noticed pixel region selection step.

Preferably, at the noticed pixel region selection step, a region wherein an autocorrelation is high in regard to each ink color to be used for printing is selected in a unit of a sensor pixel of each of the calorimeters and the selected region is set as the noticed pixel region for each ink color.

In this instance, preferably the region wherein the autocorrelation is high is a group of all pixels which exhibit an autocorrelation higher than a condition set in advance for each ink color, and, at the noticed pixel region setting step, the pixel group is automatically extracted using a computer.

According to another aspect of the present invention, there is provided a picture color tone controlling method for controlling a color tone of a printing picture when printing is carried out in response to the printing picture data using a target color set by the printing target color setting method described above, comprising a step of measuring a color on a print face before dry down or after dry down corresponding to the printing picture data by the arbitrary calorimeter and controlling an ink supplying amount so that a resulting value of the measurement approaches the value of the target color before dry down or of the target color after dry down.

In this instance, preferably an ink supplying amount is controlled for each of a plurality of ink supplying units divided in a printing widthwise direction using the target color set for the selected noticed pixel region by the printing target color setting method described above.

Preferably, the color of the print face before dry down is measured by the arbitrary calorimeter and the ink supplying amount is controlled so that a resulting value of the measurement approaches the value of the target color before dry down, and the color measurement value before dry down measured using the arbitrary calorimeter is converted, upon printing, into a color measurement value after dry down using the color characteristic and the resulting color measurement value is used for display on a monitor screen.

According to a further aspect of the present invention, there is provided a printing target color setting apparatus comprising a reference calorimeter, a color characteristic acquisition section for acquiring a color characteristic which indicates a relationship between color measurement values obtained by measuring colors of a printed matter for color measurement adjusted to reference colors before and after dry down of ink with the reference calorimeter and values of picture data of the printed matter for color measurement, a data acquisition section for acquiring printing picture data to be used for printing, and a target color setting section for setting, based on the color characteristic acquired by the color characteristic acquisition section and the printing picture data acquired by the data acquisition section, target colors before and after dry down corresponding to the value of the printing picture data as target values for a color measurement value measured by an arbitrary calorimeter having a detection characteristic which coincides with that of the reference calorimeter.

Preferably, a single color scale printed matter is prepared as the printed matter for color measurement, and the color characteristic acquisition section measures colors of the color scale printed matter before and after dry down of ink with the reference calorimeter and associates color measurement values before and after dry down measured by the reference calorimeter and picture data values of the color scale printed matter with each other to acquire the color characteristic.

Preferably, one of a color coordinate value, a spectrum value and a color density value is used as the color measurement value.

Preferably, the picture data is tone value data of each ink color to be used for printing.

Preferably, the color characteristic acquisition section acquires the color characteristic in response to a kind of a material to be used for printing, the data acquisition section acquires also material data to be used for printing, and the target color setting section sets target colors before and after dry down corresponding to the material data and the printing picture data based on the color characteristic acquired by the color characteristic acquisition section and corresponding to the kind of the material and also on the printing picture data and the material data acquired by the data acquisition section.

Preferably, the printing target color setting apparatus further comprises a noticed pixel region selection section for selecting a noticed pixel region to be noticed as a target of color tone control within a picture of the printing picture data, and the target color setting section sets the target color with regard to the noticed pixel region selected by the noticed pixel region selection section.

Preferably, the noticed pixel region selection section selects a region wherein an autocorrelation is high in regard to each ink color to be used for printing in a unit of a sensor pixel of each of the calorimeters and sets the selected region as the noticed pixel region for each ink color.

In this case, preferably the region wherein the autocorrelation is high is a group of all pixels which exhibit an autocorrelation higher than a condition set in advance for each ink color, and the noticed pixel region setting section is a functional element allocated to a computer for automatically extracting the pixel group.

According to a still further aspect of the present invention, there is provided a picture color tone controlling apparatus for controlling a color tone of a printing picture when printing is carried out in response to printing picture data using a target color set by the printing target color setting apparatus described above, comprising an arbitrary calorimeter for measuring a color on a print face before dry down or after dry down corresponding to the printing picture data, and an ink supplying amount controlling section for controlling an ink supplying amount so that a color measurement value measured by the arbitrary calorimeter approaches a target color before dry down or a target color after dry down.

Preferably, the ink supplying amount controlling section controls an ink supplying amount for each of a plurality of ink supplying units divided in a printing widthwise direction using the target color set with regard to the selected noticed pixel region by the printing target color setting apparatus described above.

Preferably, the arbitrary calorimeter is disposed so as to measure a color on the print face before dry down, and the ink supplying amount controlling section controls an ink supplying amount so that the color measurement value measured by the arbitrary calorimeter approaches the target color before dry down, the picture color tone controlling apparatus further comprising a monitor apparatus for converting, upon printing, the color measurement value before dry down measured by the arbitrary calorimeter into a color measurement value after dry down using the color characteristic and displaying the resulting color measurement value on a monitor screen.

With the printing target color setting method and apparatus of the present invention, since target colors before and after dry down are set based on color characteristics before and after dry down of ink, when printing is carried out in accordance with printing picture data using the target color, for example, where color measurement before dry down on a printing face is carried out by a colorimeter, the ink supplying amount is controlled so that the color measurement value approaches the target color before dry down. Then, the color measurement value of a printing face before dry down is measured by the calorimeter and then is converted into a color measurement value after dry down based on the color characteristics before and after dry down of ink. Thereafter, the ink supplying amount is controlled so that the color measurement value approaches the target color after dry down. Consequently, printing which provides colors approximate to the target colors before and after dry down can be carried out.

Further, the color of a printing face before dry down is measured by a calorimeter and the ink supplying amount is controlled so that the color measurement value approaches a target color before dry down and then the color measurement value before dry down by the calorimeter is converted into a color measurement value after dry down and is displayed on the monitor screen. Consequently, since the control itself is carried out with reference to the color before dry down, rapid feedback is implemented, and since the color after dry down which is evaluated normally is displayed on the monitor screen, the operator can easily manage the printing state appropriately while viewing the monitor screen.

Accordingly, in the case of newspaper printing, the sensor characteristic of colorimeters equipped for rotary presses or the like in individual factories is adjusted to the sensor characteristic (reference sensor characteristic) of a calorimeter equipped in a reference rotary press or the like and a corresponding relationship between characteristics before and after dry down once [where the corresponding relationship is provided as an LUT (look up table), the LUT]. Then, the corresponding relationship (LUT) is distributed to all factories. Consequently, the printing quality in all of the factories can be kept uniform.

Further, a target color after dry down can be converted into a target color before dry down, and the controlling process can be carried out with the color after dry down when the target color is designated and the controlling process can be carried out with the color before dry down when the target color is used for control. This provides a high supporting effect for printing management.

Conversely, a target color before dry down can be converted into a target color after dry down, and the control can be carried out with a color after dry down not only when the target color is designated and but also when the control is carried out.

In the case of newspaper printing, since a newspaper is delivered to a customer while it has a color after dry down, the color after dry down is significant. On the other hand, since the color before dry down is measured during printing by a printing press, also it is significant to convert the color after dry down into a color before dry down to carry out color tone control.

Also it is very significant in printing management that the colors before and after dry down can be confirmed on the monitor screen. For example, in the case of newspaper printing, it is particularly significant that the color tone when a newspaper is delivered to a customer can be confirmed during printing, and this provides a great supporting effect for printing management.

The above and other objects, features and advantages of the present invention will become apparent from the following description and the appended claims, taken in conjunction with the accompanying drawings in which like parts or elements are denoted by like reference characters.

### BRIEF DESCRIPTION OF THE DRAWINGS

FIG. 1 is a block diagram showing an image display apparatus for a printing picture according to an embodiment of the present invention;

FIG. 2 is a schematic diagrammatic view showing a printing color tone controlling apparatus according to the embodiment of the present invention;

FIG. 3 is a block diagram showing the image display apparatus for a printing picture according to the embodiment of the present invention together with a monitor unit;

FIGS. 4(a) to 4(d) are front elevational views of monitor images showing display examples of the image display apparatus for a printing picture according to the embodiment of the present invention, and wherein FIGS. 4(a) to 4(c) shows display examples of a color development state of printing pictures and FIG. 4(d) shows a display example as an operation terminal;

FIG. 5 is a flow chart illustrating an acquisition method of an ICC profile in the dry state according to the embodiment of the present invention;

FIG. 6 is a flow chart illustrating an acquisition method of an ICC profile in the wet state according to the embodiment of the present invention;

FIGS. 7(a) and 7(b) are front elevational views of monitor images illustrating exampled of printing picture control according to the embodiment of the present invention, and wherein FIG. 7(a) shows a color development target of a printing picture and FIG. 7(b) shows a display example of a color development state of a printing picture upon printing color tone control;

FIG. 8 is a block diagram illustrating a monitor displaying function in the dry state according to the embodiment of the present invention;

FIG. 9 is a similar view but illustrating a monitor displaying function in the wet state according to the embodiment of the present invention; and

FIGS. 10(a) to 10(c) are block diagrams illustrating the monitor displaying function in the dry state according to the embodiment of the present invention, and wherein FIG. 10(a) illustrates the entire monitor displaying function and FIGS. 10(b) and 10(c) illustrate part of the monitor displaying function.

### DESCRIPTION OF THE PREFERRED EMBODIMENT

In the following, an embodiment of the present invention is described with reference to the drawings.

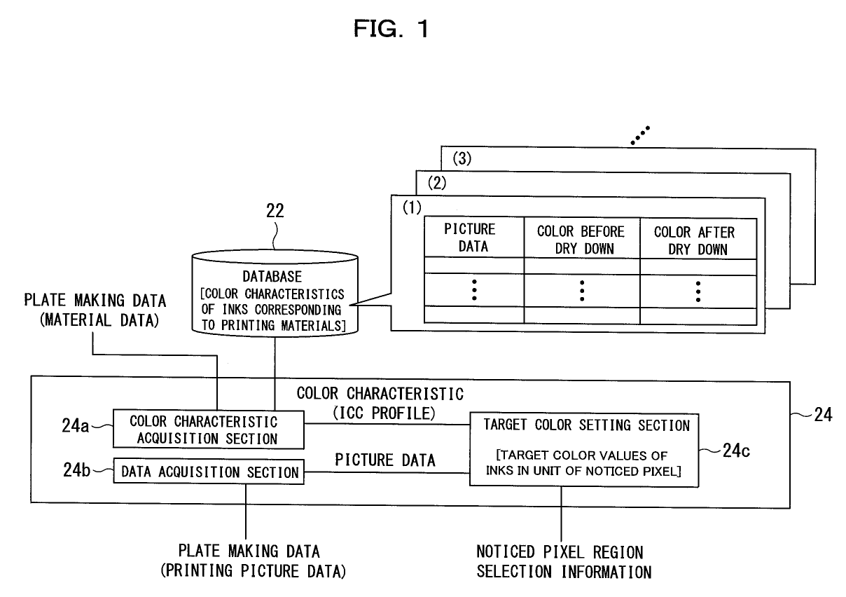

FIGS. 1 to 10c show an image display apparatus of a printing picture and a printing color tone controlling apparatus according to an embodiment of the present invention.

### [Configuration of the Quality Controlling Apparatus]

First, a quality controlling apparatus having a function of the printing color tone controlling apparatus according to the present embodiment is described.

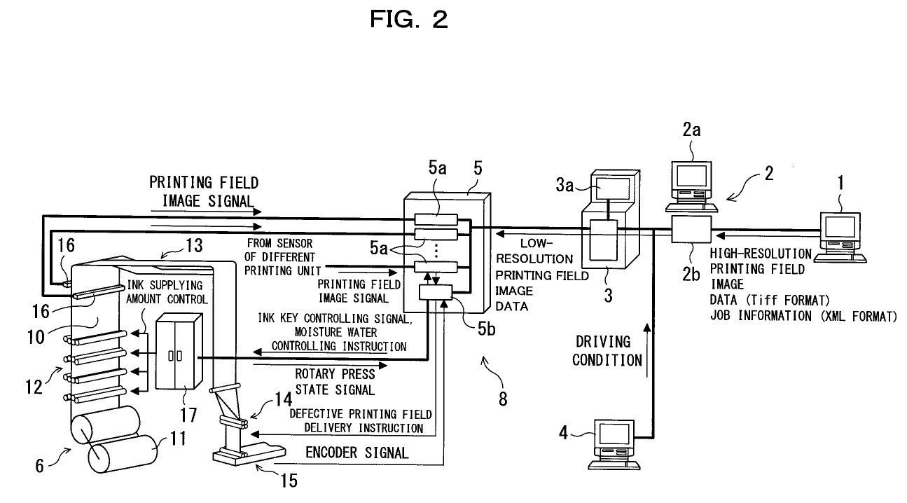

In the case of the present embodiment, the printing press is a newspaper rotary press 6 as shown in FIG. 2.

First, the newspaper rotary press 6 is described. Referring to FIG. 2, the newspaper rotary press 6 of the present embodiment is a multi-color perfecting printing press and includes a paper supplying station 11, an in-feeding station (not shown), a printing station 12, a web-pass station 13, a folding machine 14 and a paper delivery station 15. The newspaper rotary press 6 carries out printing on a web (continuous paper, hereinafter referred to sometimes as printing sheet) 10 supplied from the paper supplying station 11 by means of the printing station 12, passes through the web-pass station 13, carries out cutting and folding of the web 10 by means of the folding machine 14, and delivers the web 10 by means of the paper delivery station 15. The printing station 12 includes a calorimeter (color development state detection section), in the present embodiment, an IRGB densitometer 16, for detecting the density (actual density) as a color development state of a picture at a printing portion of the traveling web 10, and a rotary press controlling apparatus 17 for controlling the ink supplying amount (particularly, ink key) and moisture water to the printing station 12.

A quality controlling apparatus image server 2 provided for such a newspaper rotary press 6 as described above receives high-resolution printing field image data in the Tiff format and job information in the XML format as printing data from a plate making side CTP server 1 of a customer and converts the printing field image data into low-resolution image data according to predetermined standards (for example, CIP 4 standards) which can be handled by the printing press. It is to be noted that, though not shown, a printing plate is made by a CTP based on the printing field image data from the plate making side CTP server 1 of the customer.

An operation terminal personal computer 3 carries out presetting and controlling of an ink supplying amount to a predetermined unit of the rotary press based on the printing field image data and the job information after the conversion into data of the predetermined standards by the quality controlling apparatus image server (operation terminal) 2 and driving condition information from a CCS personal computer. The operation terminal personal computer 3 is used to allow an operator to carry out monitoring, issuance of an instruction and so forth when color tone control hereinafter described is carried out by ink supplying amount adjustment. Particularly, the operation terminal personal computer 3 includes a touch display unit 3a such that the operation can carry out issuance of an instruction and so forth while watching the screen image of the touch display unit 3a.

The CCS personal computer 4 is provided in a management system on the rotary press side and is used for carrying out a process of determining the position of a printing drum of a printing unit of the rotary press to which a page of the printing field image data after converted into data of the predetermined standards by the quality controlling apparatus image server 2, a process of inputting of some other driving condition and so forth.

The quality controlling apparatus 5 carries out automatic control upon printing and includes calculation apparatus 5a each for calculating a control amount regarding color tone automatic control of one of the printing presses based on a printing field image signal outputted from the IRGB densitometer 16 of each printing press. The quality controlling apparatus 5 further includes an outputting apparatus 5b which receives control amount information from the calculation apparatus 5a, state signals of the rotary presses and an encoder signal from the paper delivery station 15 and issues an ink key controlling signal, a moisture water controlling instruction and a defective paper delivery instruction regarding the color tone automatic control to carry out various controlling processes. A functional element regarding automatic color tone control by ink key control from among the functions of the quality controlling apparatus 5 corresponds to the printing color tone controlling apparatus according to the present embodiment.

It is to be noted that the operation terminal personal computer 3 can carry out various settings regarding the control to be carried out by the quality controlling apparatus 5, and a printing automatic controlling apparatus 8 is configured from the operation terminal personal computer 3 and the quality controlling apparatus 5.

It is to be noted that, in the image display apparatus of a printing picture and the printing color tone controlling apparatus according to the present embodiment, a monitor (operation terminal monitor) 2a of the quality controlling apparatus image server 2 of the quality controlling apparatus 5 is used also as a displaying monitor for displaying a printing picture and so forth when actual printing is carried out. Further, in the present embodiment, a calculation apparatus 2b of the quality controlling apparatus image server 2 is used also as a calculation apparatus for carrying out calculation for displaying a printing picture and so forth on the displaying monitor 2a.

### [Configuration of the Image Display Apparatus of a Printing Picture]

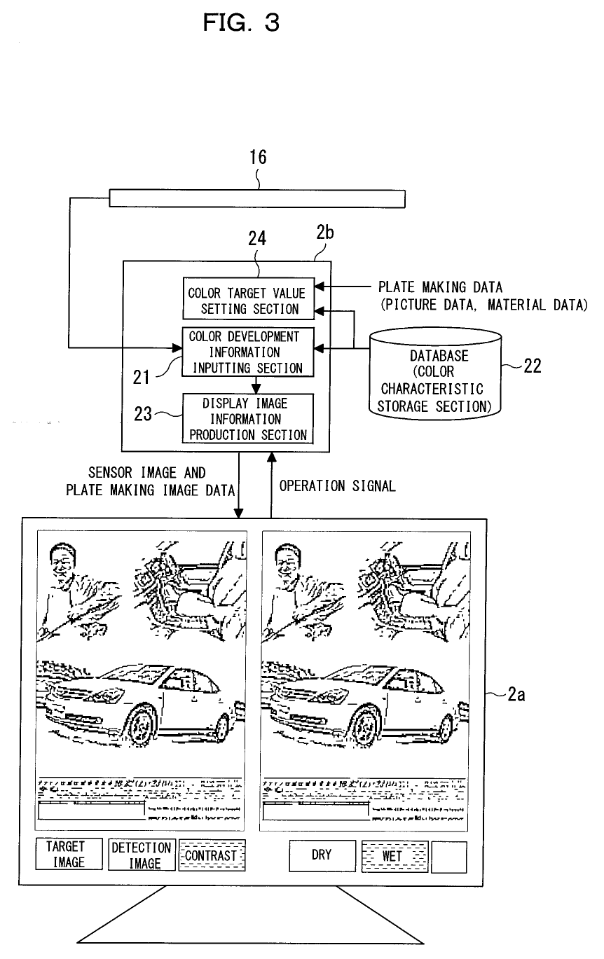

Here, the image display apparatus of a printing picture according to the present embodiment is described. As shown in FIGS. 1 and 3, the calculation apparatus 2b includes, as functions of the image display apparatus, a color development information inputting section 21 to which information of a color development state of a printing picture is inputted in a corresponding relationship to an ink dehydration level, a color development characteristic storage section 22 for storing a color development characteristic corresponding to the ink drying level and a display image information production section 23 for producing display image information at a designated ink dehydration level, and further includes a color development target setting section 24 as a function for printing color tone control. It is to be noted that the ink hydration level corresponds to what degree the ink is dried and includes states from the wet state immediately after printing to a state wherein ink is completely dried.

The color development information inputting section 21 receives detection information detected (measured) by the IRGB densitometer (color development state detection section) 16 as a calorimeter, that is, IRGB detection data of individual portions of a printing picture which indicates a color development state of a printed matter before ink dehydration on which a predetermined printing picture is printed by the printing press 6, and IRGB data of the individual portions of the printing picture which indicate a color development state corresponding to plate making data of the printing picture.

It is to be noted that, while the plate making data include tone value information k, c, m and y of the individual portions of the printing picture of the ink colors [k (black), c (cyan), m (magenta), and y (yellow)], the color development state is given as reflection density information I, R, G and B of light of the colors [I (infrared light), R (red), G (green), and B (blue)].

Accordingly, if, for example, a device profile (ICC profile 1) which indicates a relationship between sensor values I, R, G and B of the IRGB densitometer 16 and color space coordinates L*a*b* and another device profile (ICC profile 2) of the printing press 6 which indicates a relationship between plate making data k, c, m and y and color space coordinates L*a*b* are prepared, then the color development states (reflection densities) I, R, G and B detected by the IRGB densitometer (color development state detection section) 16 where printing is carried out by the printing press 6 using a printing plate corresponding to the plate making data can be obtained as color developments (reflection densities) I, R, G and B corresponding to the plate making data k, c, m and y from the plate making data k, c, m and y.

It is to be noted that, taking dry down of ink after printing into consideration, each device profile should be prepared as two device profiles including a device profile (hereinafter referred to as [device profile in the dry state]) at a dry level at which ink is completely dried (that is, as a device profile of a printed matter in the dry state normally transferred as a printed product to a consumer) and another device profile (hereinafter referred to as [device profile in the wet state]) in the wet state wherein ink is not dried, for example, at a point of time at which it is detected by the IRGB densitometer 16. The device profiles which indicate the ink drying levels described above correspond to color development characteristics corresponding to the ink drying levels, and the color development characteristic storage section 22 stores the device profiles at the individual ink drying levels. It is to be noted that an acquisition method of the device profiles is hereinafter described.

Here, while the color development states (reflection densities) I, R, G and B obtained from the plate making data k, c, m and y in such a manner as described above are inputted as a color development target (target density) to the color development information inputting section 21, the color development target (target density) can be obtained not only based on the plate making data k, c, m and y but also by measuring a printing sample (carried-in galley) using the IRGB densitometer 16. However, in this instance, since a measurement work is required separately, it is simple and easy to obtain the color development target from the plate making data k, c, m and y.

The display image information production section 23 displays the color development states inputted to the color development information inputting section 21, that is, the detection information (information of the color development state immediately after printing before ink is dried) by the IRGB densitometer 16 and the color development target (target density). For such display, a mode for displaying only a detection image (image which indicates the color development state detected by the IRGB densitometer 16) or only a target image (image which indicates the color development target) and another mode for displaying the detection image and the target image in contrast with each other can be selected, and one of such display modes is carried out in response to a designated ink drying level. Here, as the ink drying level, two level are used including a level (dry state) at which ink is completely dried and another level (wet state) at which ink is not dried at a point of time detected by the IRGB densitometer 16, and it is possible to select any of the ink drying levels and designate one of the display modes.

Here, if the mode for displaying an image which indicates a color development state of a printing picture is selected on the monitor unit 2a of the quality controlling apparatus image server 2, then a selection menu for selection of image display arrangement among single display of a detection image, single display of a target image (reference image) and contrast display of such detection and target images and another selection menu for selection of an ink drying level between the dry state and the wet state are displayed such that a mode to be displayed can be selected from the menus by operation of a mouse or the like. While the image display apparatus in a case wherein the wet state by the contrast display is selected is shown in FIG. 3, the selection menu for selection among the detection image, target image and contrast and the selection menu between the dry and wet states are displayed at a lower portion of the screen of the monitor unit 2a such that display can be changed over.

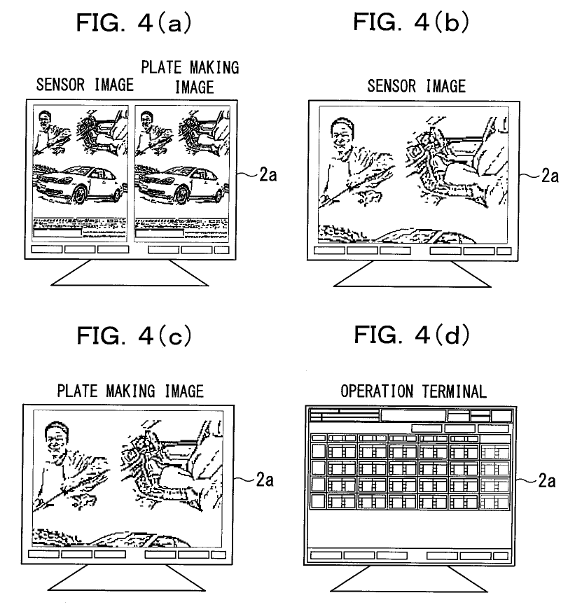

In particular, as image display arrangement on the monitor unit 2a, such contrast display of the detection image (sensor image) and the target image (plate making image) as shown in FIG. 4(a), such single display of the detection image (sensor image) as shown in FIG. 4(b) and such single display of the target image (plate making image) as shown in FIG. 4(c) are available. Further, when the monitor unit 2a of the quality controlling apparatus image server 2 is used as a terminal of the quality controlling apparatus, a terminal operation screen image is displayed as shown in FIG. 4(d).

### [Printing Color Tone Control]

Here, control by the printing color tone controlling apparatus according to the present embodiment, that is, ink key control of automatic color tone control by the quality controlling apparatus 5, is described. In the color tone control, an actual density which indicates a color development state of a detected printing picture and a target density which indicates a color development target are compared with each other and an ink supplying amount (ink key opening) is controlled so that the actual density approaches the target density. At this time, the actual density and the target density are controlled under a condition that the ink drying levels coincide with each other.

In particular, although, at a point of time at which detection is carried out by the IRGB densitometer 16, a color density of a printed matter is generally high because the printed matter is in the wet state wherein ink is not dried, the color density gradually decreases by dry down after then. On the other hand, as the target color density, a density in the dry state wherein ink is fully dried is given. Therefore, even if the color density in the wet state detected by the IRGB densitometer 16 is compared with the target color density in the dry state, correct control cannot be carried out.

Therefore, the target density in the dry state is converted into a target color density similar to that in the wet state at a point of time at which it is detected by the IRGB densitometer 16, for example, using a color development characteristic stored in the color development characteristic storage section 22, and then a color density in the wet state detected by the IRGB densitometer 16 is compared with the target color density in the wet state. Then, the ink supplying amount (ink key opening) is controlled so that the actual color density approaches the target color density.

It is to be noted here that the colors (reflection colors) I, R, G and B are included not only in the color density detected by the IRGB densitometer 16 but also in the target color density. Therefore, the developed colors are individually converted into ink color densities of individual single colors, for example, using a sensor device profile, a device profile of a printing press or the like, and the ink color density of each single color is converted into a solid density value and then the difference between the solid density value relating to the detection density and the solid density value relating to the target density is calculated. Then, if the solid density value relating to the detected color density is lower than the solid density value relating to the target color density, then the controlling process is carried out so that the ink supplying amount is increased, but if the solid density value relating to the detected color density is higher than the solid density value relating to the target color density, then the controlling process is carried out so that the ink supplying amount is decreased.

Naturally, when the actual density and the target density are used, only it is necessary to make the ink drying levels coincide with each other. Further, the color density in the wet state detected by the IRGB densitometer 16 may be converted into a color density in the dry state using the color development characteristic stored in the color development characteristic storage section 22, whereafter the solid density value of each ink relating to the detection color density in the dry state is compared with the solid density value of the ink relating to the target color density in the dry state to control the ink supplying amount.

It is to be noted that the quality controlling apparatus image server 2, which is a terminal of the quality controlling apparatus 5, can select an automatic color tone control mode and a manual color tone control mode for the printing color tone control by the quality controlling apparatus 5 such that not only the automatic color tone control by the quality controlling apparatus 5 but also manual color tone control by the operator can be carried out. Particularly, in the manual color tone control mode, the operator can carry out manual operation of the monitor unit 2a of the quality controlling apparatus image server 2 while referring to an image which is displayed on the monitor unit 2a and indicates a color development state of a printing picture.

### [Acquisition of an ICC Profile]

An ICC profile in the wet state which indicates a color characteristic before dry down of ink on a printed matter and another ICC profile in the dry state which indicates a color characteristic after dry down of ink on a printed matter can be produced by preparing a color scale printed matter as a printed matter for color measurement to measure the color before and after dry down of ink on the color scale printed matter by means of the IRGB densitometer 16 which corresponds to the reference calorimeter and associate the measured color measurement values before and after dry down with picture data values of the color scale printed matter.

The ICC profiles are described below in more detail.

### Acquisition Method of an ICC Profile in the Drying State

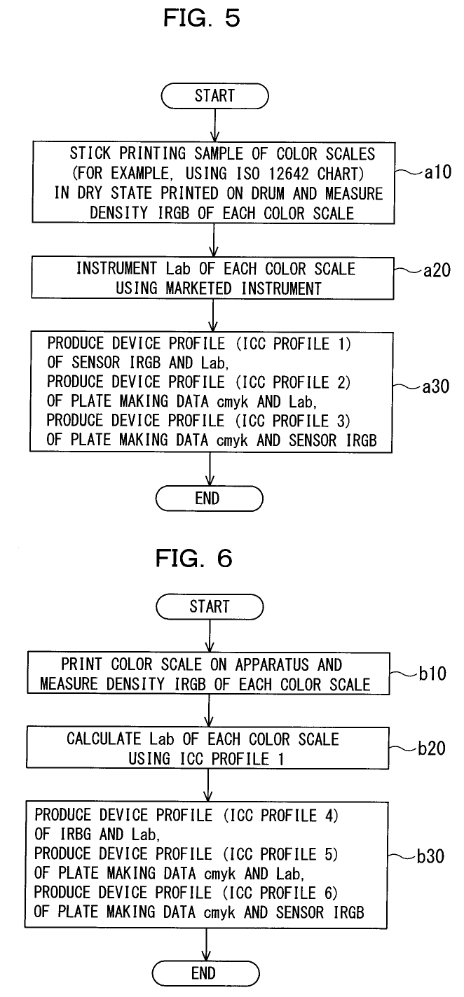

In order to acquire an ICC profile in the dry state, for example, as illustrated in the flow chart of FIG. 5, a printing sample of a color scale (for example, using the ISO 12642 chart) in the dry state printed by the printing press 6 is stuck to a rotary body and the density IRGB of the color scales is measured by the IRGB densitometer 16 (step a10).

Then, color coordinate values L*a*b* of each color scale whose densities IRGB are measured are measured using a popular instrument (step a20).

As a result, a device profile (ICC profile 1) of the IRGB densitometer 16 which corresponds to a corresponding relationship between the sensor IRGB in the dry state and the L*a*b* values can be produced.

Further, since the plate making data k, c, m and y of the used color scale (for example, ISO 12642 chart) are known, a device profile (ICC profile 2) of the printing press 6 which corresponds to a corresponding relationship between the plate making data k, c, m and y in the dry state and the L*a*b* values in the dry state can be produced.

A device profile (ICC profile 3) which indicates a corresponding relationship between the plate making data k, c, m and y and the sensor IRGB in the dry state can be produced from the ICC profiles 1 and 2 (step a30).

### Acquisition Method of an ICC Profile in the Wet State

In order to acquire an ICC profile in the wet state, for example, as illustrated in a flow chart of FIG. 6, a color scale is printed using the printing press 6 and the density IRGB of each color scale is measured by the IRGB densitometer 16 (step b10).

Then, L*a*b* values of the printed color scale is calculated using the ICC profile 1 (step b20).

As a result, a device profile (ICC profile 4) of the IRGB densitometer 16 which corresponds to a corresponding relationship between the sensor IRGB in the wet state and the L*a*b* values can be produced.

Further, since the plate making data k, c, m and y of the used color scale are known, a device profile (ICC profile 5) of the printing press 6 which corresponds to a corresponding relationship between the plate making data k, c, m and y in the wet state and the L*a*b* values can be produced.

A device profile (ICC profile 6) which indicates a corresponding relationship between the plate making data k, c, m and y in the wet state and the sensor IRGB can be produced from the ICC profiles 4 and 5 (step b30).

### [Working Effect]

Since the image display apparatus of a printing picture and the printing color tone controlling apparatus according the embodiment described above are configured in such a manner as described above, image display of a printing picture and printing color tone control can be carried out as described below.

### [Printing Color Tone Controlling Process]

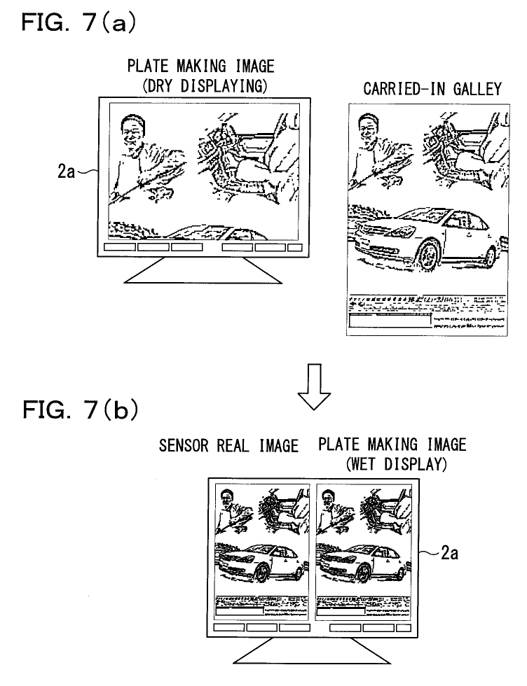

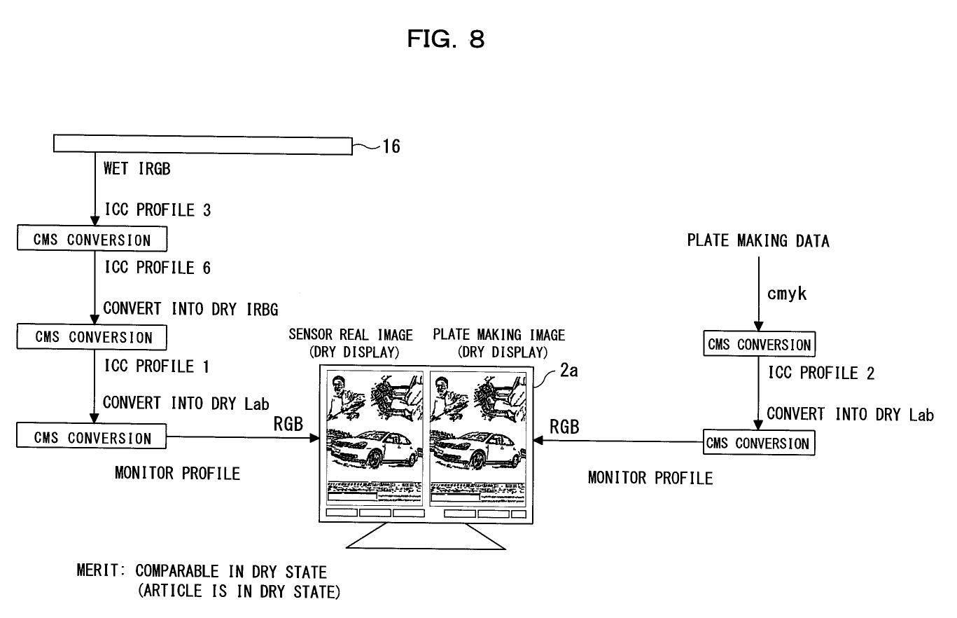

When color tone control is carried out, as seen in FIG. 7(a), a monitor simulation of a color development target in the dry state is carried out on the monitor unit 2a based on a color development state (reflection densities) I, R, G and B in the dry state obtained from the plate making data k, c, m and y or a color development state (reflection densities) I, R, G and B in the dry state obtained from the carried-in galley.

Then, as shown in FIG. 7(b), a wet button is designated to convert the color development target into that in the wet state and display the color development target in the wet state on the monitor unit 2a for contrast with a detection image (sensor real image) in the wet state.

Here, where the color tone control is carried out manually, a key is adjusted to correct the color of the detection image (sensor real image) so that the color of the detection image (sensor real image) becomes the color of the plate making image (wet display).

On the other hand, where the color tone controlling process is carried out automatically, the target density of the plate making image (wet display) is transmitted to the density controlling apparatus so that the color tone control is carried out by the density controlling apparatus.

Consequently, such effects as just described can be achieved.

(a) Since the colors of the plate making image of the color development target and the detection image during printing are displayed on the one monitor unit 2a, calibration of the monitor screen need not be carried out. Further, an expensive monitor screen for color evaluation need not be prepared.

(b) Since the monitor unit (monitor for an operation terminal) 2a of the quality controlling apparatus image server 2 of the quality controlling apparatus 5 is used also as a displaying monitor for displaying a printing picture, the installation cost for the monitor unit can be suppressed and also the space for monitor installation can be saved.

(c) Since color adjustment with an equal ink drying level (for example, a fully wet state) can be carried out, the color adjustment can be carried out accurately taking the progress of dry down into consideration.

### [Image Display of a Printing Picture]

### Monitor Display in the Dry State

Where the detection image (sensor real image) and the plate making image are displayed on the monitor unit in the dry state, as shown in FIG. 8, the IRGB values in the wet state detected by the IRGB densitometer 16 are converted into IRGB values in the dry state by CMS conversion using the ICC profile 3 and the ICC profile 6, and the resulting IRGB values are further converted into L*a*b* values in the dry state by CMS conversion using the ICC profile 1. Thereafter, the resulting L*a*b* values are displayed as an image RGB on the monitor unit 2a by CMS conversion through the monitor profile of the monitor unit 2a.

On the other hand, the plate making data k, c, m and y are converted into L*a*b* values in the dry state by CMS conversion using the ICC profile 2 and then the resulting L*a*b* values are displayed as an image RGB on the monitor unit 2a by CMS conversion through the monitor profile of the monitor unit 2a.

By displaying both of the detection image and the plate making image as images in the dry state on the monitor unit 2a in this manner, the operator can suitably carry out the color adjustment while referring to a color tone near to that of an actual commodity which is supplied in the dry state on the monitor unit 2a.

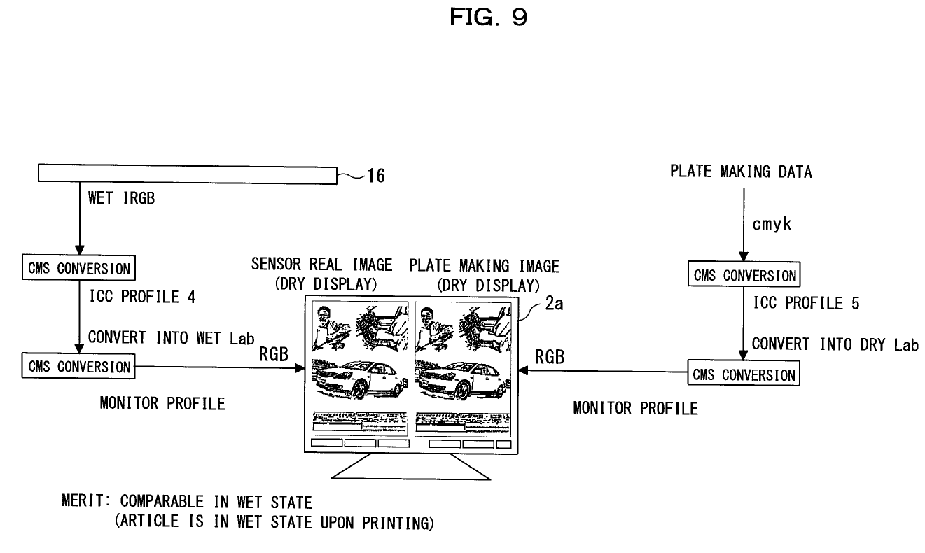

### Monitor Display in the Wet State

Where the detection image (sensor real image) and the plate making image are displayed in the wet state on the monitor unit, as shown in FIG. 9, the IRGB values in the wet state detected by the IRGB densitometer 16 is converted into L*a*b* values in the wet state by CMS conversion using the ICC profile 4 and then the resulting L*a*b* values are displayed as an image on the monitor unit 2a by CMS conversion through the monitor profile of the monitor unit 2a.

On the other hand, the plate making data k, c, m and y are converted into L*a*b* values in the wet state by CMS conversion using the ICC profile 5 and then the resulting L*a*b* values are displayed as an image RGB on the monitor unit 2a by CMS conversion through the monitor profile of the monitor unit 2a.

Since, by displaying the detection image and the plate making image as images in the wet state on the monitor unit 2a, the color adjustment is carried out while using the detection data by the IRGB densitometer 16 as they are without converting the detection data into detection data in the dry state, the operator can suitably carry out the color adjustment while reducing the calculation burden of the detection data on the calculation apparatus. Particularly, it is expected that the reduction merit of the calculation burden is great when the color adjustment is automatically carried out.

Further, also there is an advantage that, since a printed matter is in the wet state, it provides no unfamiliar feeling between the color tone on the monitor and the color tone of the printed matter. On the contrary, if the comparison is carried out in the dry state, then since the color tone on the monitor and the color tone of the printed matter do not match with each other, an unfamiliar feeling is provided.

Further, this is studied in the case of newspaper printing. As regards a calorimeter, the sensor characteristic of colorimeters equipped for rotary presses or the like in individual factories is adjusted to the sensor characteristic (reference sensor characteristic) of a calorimeter equipped in a reference rotary press or the like and a corresponding relationship between characteristics before and after dry down once [where the corresponding relationship is provided as an LUT (look up table), the LUT]. Then, the corresponding relationship (LUT) is distributed to all factories. Consequently, the printing quality in all of the factories can be kept uniform. For example, if a client buys a newspaper in an A district and then goes to a B district on a business trip and reads a like newspaper there, that it is a significant advantage to the newspaper publication side in terms of quality assurance that the newspapers are printed in a uniform color tone.

Further, a target color after dry down can be converted into a target color before dry down, and the controlling process can be carried out with the color after dry down when the target color is designated and the controlling process can be carried out with the color before dry down when the target color is used for control. The fact just described is very significant for printing management. In particular, since, in the case of newspaper printing, the color of the newspaper when the newspaper comes to the customers is a color after dry down, the color after dry down is important. However, the color before dry down is measured during printing by a printing press. Accordingly, also it is important to convert the color after dry down into a color before dry down to carry out the color tone control.

Further, also it is very significant for printing management that the color before and after dry down can be confirmed on a monitor screen. In the case of newspaper printing, it is very useful that the color tone when a newspaper comes to a reader can be confirmed during printing. Consequently, it is possible to equally compare the color tone with that of a galley (printing sample) after dry down and confirm and correct the color tone. On the other hand, also it is very significant that the color tone in the wet state can be confirmed on a monitor screen. Consequently, the labor for the operator to go to fetch a sample to a paper delivery apparatus can be eliminated, and it is possible to prevent time delay from a printing unit to a paper delivery apparatus and always confirm a printed matter immediately after printed. Further, it becomes easy to find out a fault, a defect or the like of the color upon printing.

Naturally, such effects as described above are achieved not only by newspaper printing.

### [Improved Resolution Display of a Sensor Image]

Since normally the resolution of a sensor image is lower than that of a plate making image, where color adjustment is carried out while monitor display is referred to, it is very effective to improve the resolution of the sensor image in order to improve the accuracy of the color adjustment.

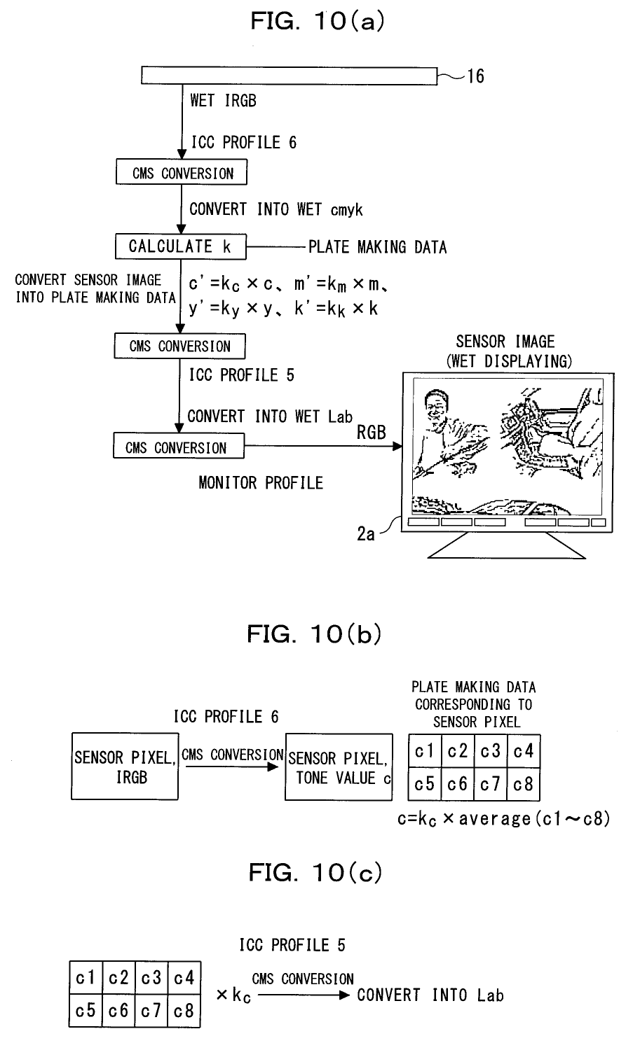

Therefore, it seems a possible idea to improve the resolution of the sensor image using plate making data corresponding to sensor pixels as seen in FIG. 10(a). In particular, IRGB values in the wet state which are detection data by the IRGB densitometer 16 are first converted into tone values k, c, m and y in the wet state by CMS conversion using the ICC profile 6. The tone value k, c, m and y obtained by converting the IRGB values of the sensor pixels in the wet state can be associated with the tone values k, c, m and y of plate making data at a corresponding position.

While tone values c are illustrated in FIG. 10(b), since the pixels of the plate making data are finer than the sensor pixels, a great number of tone values c1 to c8 of the plate making data exist with respect to the tone value c of one sensor pixel. Here, the ratio value (coefficient) k_{c} [c=k_{c}×average (c1 to c8)] of an average value among the tone values c1 to c8 of the plate making data to the tone value c of the sensor pixel is calculated. Then, as illustrated in FIG. 10(c) regarding the tone value c, by multiplying the tone value c of the plate making data corresponding to the sensor pixels by the calculated coefficient k_{c}, a tone value c′ in a unit of a pixel of the plate making data whose pixels are finer than the sensor pixels can be obtained.

As seen in FIG. 10(a), coefficients kₖ, k_{c}, kₘ and k_{y} are calculated for each ink color. Then, the tone values k, c, m and y of the plate making data corresponding to the sensor pixels can be multiplied by the calculated coefficients kₖ, k_{c}, kₘ and k_{y} to obtain tone values k′, c′, m′ and y′ in a unit of a pixel of the plate making data whose pixels are finer than the sensor pixels. The tone values k′, c′, m′ and y′ obtained in such a manner as just described are converted into L*a*b* values in the wet state by CMS conversion using the ICC profile 5 and then the resulting L*a*b* values are displayed as an image RGB on the monitor unit 2a by CMS conversion through the monitor profile of the monitor unit 2a.

Consequently, the sensor image can be displayed in a unit of a pixel of the plate making data whose pixels are finer than the sensor pixels. Therefore, the apparent resolution of the sensor image increases, and the accuracy of the color adjustment can be enhanced also with regard to a detailed portion of an image such as, for example, hair, grain of wood or the like.

### [Others]

While the embodiment of the present invention is described above, the embodiment of the present invention is not limited to that described above.

For example, the sensor for color density detection to be incorporated as a color development state detection section on a line of a printing press is not limited to an IRGB densitometer but an RGB densitometer may be used as the sensor. Further, various sensors such as a sensor in which a camera or the like is used can be applied as the sensor.

Further, in the embodiment described above, the level (dry state) at which ink is fully dried and the level (wet state) at which ink at a point of time at which detection by the IRGB densitometer 16 is carried out is not dried are set for the ink drying level. However, for example, where a printed matter is supplied at a point of time before dry down of ink is completed or in a like case, the ink drying level at a point of time of supply of the printed matter may be set and displayed on a monitor. In this manner, various ink drying levels can be assumed.

Further, also acquisition of the ICC profiles is not limited to that in the embodiment described.

What is claimed is:

1. A printing target color setting method, comprising:
a color characteristic acquisition step of acquiring a color characteristic which indicates a corresponding relationship between color measurement values obtained by measuring colors of a printed matter for color measurement adjusted to reference colors before and after dry down of ink with a reference calorimeter and values of picture data of the printed matter for color measurement;
a data acquisition step of acquiring printing picture data to be used for printing; and
a target color setting step of setting, based on the color characteristic acquired at the color characteristic acquisition step and the printing picture data acquired at the data acquisition step, target colors before and after dry down corresponding to a value of the printing picture data as target values for a color measurement value by an arbitrary calorimeter having a detection characteristic which coincides with that of the reference calorimeter.

2. The printing target color setting method as claimed in claim 1, wherein a single color scale printed matter is prepared as the printed matter for color measurement, and,
at the color characteristic acquisition step, colors of the color scale printed matter before and after dry down of ink are individually measured by the reference calorimeter and color measurement values before and after dry down measured by the reference calorimeter and picture data values of the color scale printed matter are associated with each other to acquire the color characteristic.

3. The printing target color setting method as claimed in claim 1, wherein one of a color coordinate value, a spectrum value and a color density value is used as the color measurement value.

4. The printing target color setting method as claimed in claim 1, wherein the picture data is tone value data of each ink color to be used for printing.

5. The printing target color setting method as claimed in claim 1, wherein, at the color characteristic acquisition step, the color characteristic is acquired in response to a kind of a material to be used for printing;
at the data acquisition step, also material data to be used for printing is acquired; and
at the target color setting step, target colors before and after dry down corresponding to the printing picture data and the material data are set based on the color characteristic acquired at the color characteristic acquisition step and corresponding to the kind of the material and also on the printing picture data and the material data acquired at the data acquisition step.

6. The printing target color setting method as claimed in claim 1, wherein the target color setting step includes a noticed pixel region selection step of selecting a noticed pixel region to be noticed as a target of color tone control within a picture of the printing picture data, and
the target color is set for the noticed pixel region selected at the noticed pixel region selection step.

7. The printing target color setting method as claimed in claim 6, wherein, at the noticed pixel region selection step, a region wherein an autocorrelation is high in regard to each ink color to be used for printing is selected in a unit of a sensor pixel of each of the calorimeters and the selected region is set as the noticed pixel region for each ink color.

8. The printing target color setting method as claimed in claim 7, wherein the region wherein the autocorrelation is high is a group of all pixels which exhibit an autocorrelation higher than a condition set in advance for each ink color, and,
at the noticed pixel region setting step, the pixel group is automatically extracted using a computer.

9. A picture color tone controlling method for controlling a color tone of a printing picture using a target color set by the printing target color setting method as claimed in claim 1 so that a color measurement value by the arbitrary calorimeter becomes the set target value, comprising:
a step of measuring a color on a print face before dry down or after dry down corresponding to the printing picture data in response to a color measurement time point of the arbitrary calorimeter and controlling an ink supplying amount so that a resulting value of the measurement approaches the value of the target color before dry down or of the target color after dry down.

10. The picture color tone controlling method as claimed in claim 9, wherein the target color setting step of the printing target color setting method includes a noticed pixel region selection step of selecting a noticed pixel region to be noticed as a target of color tone control within a picture of the printing picture data and the target color is set for the noticed pixel region selected at the noticed pixel region selection step, and an ink supplying amount is controlled for each of a plurality of ink supplying units divided in a printing widthwise direction using the target color set for the selected noticed pixel region.

11. The picture color tone controlling method as claimed in claim 9, wherein the color of the print face before dry down is measured by the arbitrary calorimeter and the ink supplying amount is controlled so that a resulting value of the measurement approaches the value of the target color before dry down, and
the color measurement value before dry down measured using the arbitrary calorimeter is converted, upon printing, into a color measurement value after dry down using the color characteristic and the resulting color measurement value is used for display on a monitor screen.

12. A printing target color setting apparatus, comprising:
a reference calorimeter;
a color characteristic acquisition section for acquiring a color characteristic which indicates a relationship between color measurement values obtained by measuring colors of a printed matter for color measurement adjusted to reference colors before and after dry down of ink with said reference calorimeter and values of picture data of the printed matter for color measurement;
a data acquisition section for acquiring printing picture data to be used for printing; and
a target color setting section for setting, based on the color characteristic acquired by said color characteristic acquisition section and the printing picture data acquired by said data acquisition section, target colors before and after dry down corresponding to the value of the printing picture data as target values for a color measurement value measured by an arbitrary calorimeter having a detection characteristic which coincides with that of said reference calorimeter.

13. The printing target color setting apparatus as claimed in claim 12, wherein a single color scale printed matter is prepared as the printed matter for color measurement, and
said color characteristic acquisition section measures colors of the color scale printed matter before and after dry down of ink with the reference calorimeter and associates color measurement values before and after dry down measured by the reference calorimeter and picture data values of the color scale printed matter with each other to acquire the color characteristic.

14. The printing target color setting apparatus as claimed in claim 12, wherein one of a color coordinate value, a spectrum value and a color density value is used as the color measurement value.

15. The printing target color setting apparatus as claimed in claim 12, wherein the picture data is tone value data of each ink color to be used for printing.

16. The printing target color setting apparatus as claimed in claim 12, wherein said color characteristic acquisition section acquires the color characteristic in response to a kind of a material to be used for printing;
said data acquisition section acquires also material data to be used for printing; and
said target color setting section sets target colors before and after dry down corresponding to the material data and the printing picture data based on the color characteristic acquired by said color characteristic acquisition section and corresponding to the kind of the material and also on the printing picture data and the material data acquired by said data acquisition section.

17. The printing target color setting apparatus as claimed in claim 12, further comprising a noticed pixel region selection section for selecting a noticed pixel region to be noticed as a target of color tone control within a picture of the printing picture data, and
said target color setting section sets the target color with regard to the noticed pixel region selected by said noticed pixel region selection section.

18. The printing target color setting apparatus as claimed in claim 17, wherein said noticed pixel region selection section selects a region wherein an autocorrelation is high in regard to each ink color to be used for printing in a unit of a sensor pixel of each of the calorimeters and sets the selected region as the noticed pixel region for each ink color.

19. The printing target color setting apparatus as claimed in claim 18, wherein the region wherein the autocorrelation is high is a group of all pixels which exhibit an autocorrelation higher than a condition set in advance for each ink color, and
said noticed pixel region setting section is a functional element allocated to a computer for automatically extracting the pixel group.

20. A picture color tone controlling apparatus for controlling a color tone of a printing picture when printing is performed in response to printing picture data using a target color set by the printing target color setting apparatus as claimed in claim 13, comprising:
an arbitrary calorimeter for measuring a color on a print face before dry down or after dry down corresponding to the printing picture data; and
an ink supplying amount controlling section for controlling an ink supplying amount so that a color measurement value measured by said arbitrary calorimeter approaches a target color before dry down or a target color after dry down.

21. The picture color tone controlling apparatus as claimed in claim 20, wherein said color characteristic acquisition section acquires the color characteristic in response to a kind of a material to be used for printing and said data acquisition section acquires also material data to be used for printing, and said target color setting section sets target colors before and after dry down corresponding to the printing picture data and the material data based on the color characteristic acquired by said color characteristic acquisition section and corresponding to a kind of the material and also on the printing picture data and the material data acquired by said data acquisition section, said ink supplying amount controlling section controlling an ink supplying amount for each of a plurality of ink supplying units divided in a printing widthwise direction using the target color set with regard to the selected noticed pixel region.

22. The picture color tone controlling apparatus as claimed in claim 20, wherein said arbitrary calorimeter is disposed so as to measure a color on the print face before dry down; and
said ink supplying amount controlling section controls an ink supplying amount so that the color measurement value measured by said arbitrary calorimeter approaches the target color before dry down;
said picture color tone controlling apparatus further comprising a monitor apparatus for converting, upon printing, the color measurement value before dry down measured by said arbitrary calorimeter into a color measurement value after dry down using the color characteristic and displaying the resulting color measurement value on a monitor screen.
